(19) United States
(12) Patent Application Publication
(10) Pub. No.: US 2008/0138495 A1
(43) Pub. Date: Jun. 12, 2008

(54) Stabilized Fruit Pulp Composition and a Puree Composition Comprising the Same

(76) Inventors: Anthony John Barraclough, Kettering (GB); Frederik Michiel Meeuse, Vlaardingen (NL); Jan Alders Wieringa, Poznan (PL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/562,173

(22) PCT Filed: Jun. 7, 2004
(86) PCT No.: PCT/EP2004/006424

§ 371 Date: Dec. 17, 2007

(30) Foreign Application Priority Data
Jun. 23, 2003 (EP) 03253938.9
Dec. 16, 2003 (EP) 03257912.0

(51) Int. Cl. A23L 1/212; A23L 1/064; A23B 7/005

(52) U.S. Cl. 426/632; 426/615

(57) ABSTRACT

A stabilized fruit pulp comprising chunks of dimensions 1×1×1 mm to 15×15×15 mm is described. The stabilized fruit pulp has not been subjected to temperatures that exceed 90 degrees centigrade, has substantially no active polypenol oxidase, and is suitable for use in puree compositions that can be used in dressings, dips and spreads.

### FIELD OF THE INVENTION

The present invention is directed to a stabilized fruit pulp composition comprising chunks of said fruit as well as a stable puree composition comprising the same. More particularly, the invention is directed to a stabilized fruit pulp composition comprising chunks of said fruit, wherein said pulp composition has not been subjected to chemical treatment, high vacuum processing and temperatures over about 90° C. The stabilized fruit pulp composition of the present invention unexpectedly has an extended shelf life at about ambient temperature, may be added to a thickening base to produce a stable puree composition having a viscosity of at least about 5,000 centipoise, and is suitable for human consumption.

### BACKGROUND OF THE INVENTION

Consumption of nutrients, like antioxidants and folic acid, which are abundant in fruits and vegetables, has been linked to a lower incidence of cardiovascular disease. Moreover, it is well settled that eating fruits high in soluble fiber can reduce cholesterol levels which protects against atherosclerosis.

Other advantages of having a diet high in fruit include better athletic performances, reduced risk of developing chronic bronchitis, a lowered risk of getting most common cancers (including breast cancer), as well as a lowered risk of getting cataracts.

While food products, like dressings, dips and spreads, comprising fruits have been linked to health benefits in humans, such products are often difficult to prepare for sale in commerce. This is true because the quality of food products comprising fruit often deteriorates (e.g., browns, darkens, grows mold and/or changes or reduces flavor) due to enzymatic reactions within the food product, thereby resulting in a product that has a short shelf life and does not have an appealing look or taste after spending a limited period of time in conventional commercial channels.

Known techniques have been used to inhibit the deterioration of food products comprising fruits. These known techniques include pasteurization of the fruit, high vacuum processing for removing oxygen, and chemically treating the fruit with sulfiting agents before making the food product. The above-described known techniques do not eliminate, for example, browning and darkening in food products comprising fruit, and such techniques have adverse effects on the flavor, aroma, texture and nutritional value of the fruits treated, as well as the food products prepared therefrom.

Also, such techniques and conventional food processing techniques often lead to products which do not have good texture and/or which feel soft or mushy in the mouth when eaten. This is not always a texture or mouthfeel which is desired by consumers.

It is of increasing interest to develop a stabilized fruit pulp composition and a stable puree composition (i.e., food product) that does not, for example, easily brown, darken and changes or reduces flavor and that has an extended shelf life at about ambient temperature. It is also of increasing interest to develop a stabilized fruit composition that has good organoleptic properties e.g. mouthfeel and which has a good texture. In particular, it is of increasing interest to develop a composition which does not feel too soft or mushy in the mouth and in which the consumer can detect distinct pieces of fruit but which pieces at the same time are not undesirably large. This invention, therefore, is directed to a stabilized fruit pulp composition that has not been subjected to chemical treatment, high vacuum processing and temperatures over about 90° C. The stabilized fruit pulp composition of this invention can be used to make a stable puree composition having a viscosity of at least about 5,000 centipoise. Moreover, the stabilized fruit pulp composition of this invention and the stable puree composition prepared therefrom unexpectedly have an extended shelf life at about ambient temperature and substantially the same visual, texture, aroma and taste attributes of a pulp composition and puree composition made on demand from freshly picked fruits.

### Additional Information

Efforts have been disclosed for making fruit pump. In U.S. Pat. No. 5,384,147, a method for processing avocado pulp is described.

Other efforts have been disclosed for making stabilized fruit. In U.S. Pat. No. 5,871,794, a guacamole composition with tomatillo pulp is described.

Still other efforts have been disclosed for making creamy food formulations. In U.S. Pat. No. 6,284,303, a vegetable based creamy food is described.

None of the additional information above describes a stabilized fruit pulp that has not been subjected to chemical treatment, high vacuum processing and temperatures that exceed about 90° C.

### SUMMARY OF THE INVENTION

In a first aspect, the present invention is directed to a stabilized fruit pulp composition comprising:
(a) from about 50.0% to about 99.0% by weight water;
(b) fruit pulp comprising chunks, said chunks having dimensions of from 1×1×1 mm to 15×15×15 mm; and
(c) 0.01 to about 40.0% by weight oil,
   wherein the stabilized fruit pulp composition is the product of fruit comprising water, pulp comprising said chunks, and oil that has been heated to a temperature from about 30° C. to a temperature not over about 90° C. for less than about four minutes and the fruit has a hardness factor of at least about 300 dynes prior to heating.

In a second aspect, the present invention is directed to a stable puree composition comprising:
(a) from about 20.0 to about 95.0% by weight water;
(b) from about 0.01 to about 10.0% by weight thickening base; and
(c) 1 to about 75.0% by weight of stabilized fruit pulp composition comprising chunks, said chunks having dimensions of from 1×1×1 mm to 15×15×15 mm.
   wherein the puree composition has a viscosity from about 5,000 to about 90,000 (preferably from about 18,000 to about 30,000 centipoise) centipoise, and a shelf life at about ambient temperature of at least about 65 days.

In a third aspect, the present invention is directed to a method for making the stabilized fruit pulp composition of the first aspect of this invention.

In a fourth aspect, the present invention is directed to a method for making the stabilized puree composition of this invention.

Fruit, as used herein, means the ripening part of a plant and usually the seed bearing part of a plant. Fresh and/or frozen fruit may be used. Oil means naturally occurring triglycerides and their derivatives found in (i.e., originating in) the stabilized fruit pulp composition.

Stabilized (or stable) means substantially no mold growth, browning, darkening and flavor change or reduction for at least about 65 days, and preferably, for at least about 85 days when kept in a covered (i.e., sealed) package at about ambient temperature.

Puree is defined to mean a composition comprising stabilized fruit pulp composition and thickening base whereby the composition can be used, for example, as a dressing, dip, spread, baking additive, cooking additive, or any combination thereof.

Thickening base is defined to mean an agent that can be flavored and colored to mimic most characteristics of the stabilized fruit pulp composition and aid in viscosity maintenance of the stable puree composition prepared therefrom.

Viscosity, as used herein, means deformation properties obtained with a Haake Rheometer equipped with a set of concentric, bob-in-cup, cylinders (3 mm gap) wherein the bob employed has a diameter of 30.4 mm, the cup has a diameter of 42 mm, and shearing occurs by ramping cylinder oscillation at a rate from 0 to 135 reciprocal seconds at ambient temperature. Viscosity reported is taken at a shear rate of 10 reciprocal seconds.

Hardness factor, as used herein, means the hardness value obtained on a 4 mm thick slice of fruit (using a TA-TX2 Texture Analyzer made available by SMS Stable Micro Systems) at ambient temperature being subjected to compression using a 50 kg load cell moving at 1 mm/sec, with the hardness factor being determined from the observed first peak in a force distance curve.

### DETAILED DESCRIPTION OF THE PREFERRED EMBODIMENTS

There is no limitation with respect to the type of fruit that may be used to make the stabilized pulp composition and stable puree composition of the present invention, as long as the fruit is one that is suitable for human consumption. Often, the fruit used in this invention is an avocado, banana, mango, guava, fig, papaya, kiwi, star fruit, pineapple, combination thereof, or the like. In a most preferred embodiment, the fruit employed in this invention is avocado.

When selecting the fruit to make the stabilized fruit pulp composition and stable puree composition of this invention, the fruit is generally picked from about 1 to about 4 weeks, and preferably, from about 1 to about 3 weeks, and most preferably, from about 2 to about 3 weeks prior to being ripe. The picked fruit is then stored in a dark room (at a temperature between about 10° C. to about 35° C.) for less than about 1.5 weeks, and preferably, less than about 1 week, and most preferably, less than about 3 days. In an especially preferred embodiment, the fruit selected for use in this invention, after being picked or harvested, is subjected to storage conditions of relative humidity between about 40-70%, and most preferably, between about 50-65%.

When preparing the fruit selected for use in this invention, the fruit is, in no particular order, peeled and depitted or cored, if necessary. The resulting fruit flesh is then mashed to a desired texture or consistency to produce fruit pulp provided that chunks having the size according to the invention are present. Alternatively, the fruit is cut rather than mashed to produce chunks of the required size. It is preferred that the dimensions of the chunks are from about 2×2×2 mm to about 10×10×10 mm, preferably from about 3×3×3 mm to about 5×5×5 mm. In a preferred embodiment, the fruit pulp produced is prepared from fruit having a hardness factor from about 300 dynes to about 3,000 dynes. The fruit pulp is then heated (e.g., in a water bath, in an oven, microwave oven, in surface scraped heat exchangers, intube heat exchangers, by steam injection or with adiabatic heating in a high pressure vessel) to a temperature from about 30° C. to a temperature not over about 90° C. for less than about 4 minutes, and preferably, from about 10 seconds to about 3.5 minutes, thereby producing a stabilized fruit pulp having from about 0.01 to about 20.0% (preferably at least about 5.0% and most preferably at least about 10.0%) by weight oil and substantially no active enzymes (i.e., all quality detrimental enzymes like amylase, lipoxyginase, polyphenol oxidase (PPO) are substantially inactivated).

The fruit pulp may comprise only the fruit chunks having the desired particle size, or, the pulp may comprise the aforementioned fruit chunks in combination with smaller or larger chunks. It is especially preferred that the fruit pulp comprises at least 20% by weight of the claimed chunks, preferably at 30-100% by weight, most preferably 40-90% by weight.

In yet another preferred embodiment, acidulant is added to and mixed within the fruit pulp prior to heating. When acidulant is used, it typically makes up from about 0.01 to about 5.0% by weight of the fruit pulp being heated. The acidulant which may be used in this invention includes those which are typically used in food compositions, like lactic acid, citric acid, sorbic acid, hydrochloric acid, ascorbic acid, phosphoric acid, mixtures thereof, and the like.

There is no limitation with respect to the thickening base which may be used in this invention as long as the base is suitable for human consumption. Such a thickening base is typically a citrus fiber or vegetable puree (or mixture thereof) containing composition comprising water insoluble fibers. Therefore, the thickening base employable in this invention has food components derived from, for example, plant material that are generally resistant to digestion and absorption in the human small intestine. The thickening base can be, for example, sweetened or unsweetened applesauce, or sweetened or unsweetened cellulosic material derived from the core of an orange or other citrus fruits. Such a cellulosic material can comprise rag and small amounts of peel from the citrus fruit. Typically, the citrus fiber that makes up the thickening base of the present invention is substantially similar to or the same as the texturizing properties of the stabilized fruit pulp composition used to make the stable puree composition of this invention. Preferably, the citrus fiber within the thickening base, in dry form, has a particle size from about 50 microns to about 200 microns, including all ranges subsumed therein, and the types of thickening bases that may be used in this invention include those made commercially available from suppliers like Herbstreith & Fox, BASF Corporation and FMC Corporation.

When making the stable puree composition of the present invention, typically from about 20.0 to about 95.0%, and preferably, from about 25.0 to about 75.0%, and most preferably, from about 50.0 to about 65.0% by weight water is combined with from about 0.01 to about 10.0%, and preferably, from about 0.01 to about 7.5%, and most preferably, from about 1.0 to about 3.5% by weight thickening base, based on total weight of the stable puree composition and including all ranges subsumed therein. The resulting base combination is then mixed (preferably with conditions at ambient temperature and atmospheric pressure) to produce a base suspension. The thickening base suspension and the fruit pulp comprising chunks may be stabilized by the heating step separately, although, according to one preferred embodiment the thickening base and the fruit pulp comprising chunks are mixed together before the stabilisation step occurs so that they undergo the stabilisation step together.

Optional additives may be employed in this invention, and added, for example, to the base combination. The optional additives which may be used include artificial and natural food grade flavors and colors; protein powders like whey protein; preservatives like potassium sorbate and sodium benzoate; gums like pectin, xanthan gum and guar gum; emulsifiers like monoglycerides, diglycerides, and polysorbate; acids to modify pH like lactic acid and hydrochloric acid; spices like salt, ginger, nutmeg, basil, cinnamon, onion, garlic and pepper; and texturizing agents like microcrystalline cellulose (e.g., Avicel as made available by FMC Corporation).

While such optional additives may be added at anytime during the process for making the stable puree composition of this invention, they are preferably added to the base combination and just prior to generating the base suspension. In a preferred embodiment, however, when flavor is a desired optional additive, the flavor is added just prior to generating the puree composition of this invention. In yet another preferred embodiment, about 5.0 to about 10.0% by weight of the total water added to make the base suspension is added with the optional additives.

The flavors used in this invention may be added according to taste and the colors are added according to color preferences. The acids to modify pH are added to bring the pH of the stable puree composition to at least about 3.0, but less than or equal to about 4.1 during the heating step of the preparation process. The preferred amount of acid added to the base combination results in a stable puree composition having a pH from about 3.3 to about 4.0. After the acids have been added to bring the pH within the aforementioned pH range and the stabilisation step has taken place, the pH of the fruit pulp or fruit puree can be increased e.g. by adding an edible hydroxide such as sodium hydroxide. There are no pH restrictions for the final stabilized fruit pulp or stabilized fruit puree, provided that the pH thereof during the stabilisation step is in the range given herein. The emulsifiers and preservatives are added to enhance stability of the puree composition. The spices employed are added to taste, the gums are added to maintain a desired stable puree composition viscosity and the protein powders are added as desired. Generally, the amount of optional additives employed in the puree composition does not exceed 10.0% by weight of the total weight of the stable puree composition.

Subsequent to generating the base suspension, the same is subjected to a standard colloid mill having gap widths from about 125 microns to about 1250 microns, and preferably, from about 250 microns to about 750 microns, or a homogenizer operating under pressures from about 30 to about 300 bar. The resulting milled or homogeneous suspension is then combined with the claimed stabilized fruit pulp composition to produce the stable puree composition of this invention. The amount of stabilized fruit pulp composition employed is typically from about 1.0 to about 75.0%, and preferably, from about 5.0 to about 50.0%, and most preferably, from about 10.0 to about 25.0% by weight stabilized fruit pulp composition, based on total weight of the stable puree composition.

In an especially preferred embodiment, a fat additive may be added to the base suspension. Such a fat additive can be natural or synthetic and is a component delivered to the stable puree composition distinct from any oil delivered with the stabilized fruit pulp composition. The fat additive can be, for example, corn oil, cotton seed oil, olive oil, canola oil, palm oil, safflower oil, rapeseed oil, soybean oil, mixtures thereof and the like. The fat additive may also be a fat substitute such as fatty acid-esterified propoxylated glycerin compositions as well as sucrose fatty acid polyesters. When employed, the fat additive makes up from about 0.5 to about 25.0%, and preferably, from about 5.0 to about 20.0% by weight of the puree composition, based on total weight of the stable puree composition.

The stable puree composition of this invention is suitable for numerous food applications. For example, the composition may be used as a dressing, dip or spread, or as cooking or baking additive. Such a stable puree composition can be packaged in conventional food packaging (e.g., plastic or glass bottles) and hot filling (i.e., pasteurization) is not required to maintain product stability.

The following examples are provided to facilitate an understanding of the present invention. The examples are not intended to limit the scope of the invention as set forth in the claims.

### Example 1

Avocado, having a hardness factor of about 300 dynes, was harvested about 2.5 weeks prior to being ripe and stored in a dark room kept at about 25° C. (relative humidity about 55%) for about two (2) days.

The avocado was cut in half and depitted to produce an avocado half. The avocado half was peeled, mashed so that it had a particle size of 3×3×3 mm and mixed with 0.5% by weight ascorbic acid and then heated to about 85° C. for 3.0 minutes. The heated mashed avocado was cooled, thereby producing stabilized avocado pulp composition having about 15% by weight oil and 80.0% by weight water, with substantially no active polyphenol oxidase.

### Example 2

Avocado pulp was obtained from a commercial supplier. The avocado pulp was acidified to a pH of 4.3. The pulp was heated for 2 min at a temperature of 75 C. The product was packed. After two days the pulp had turned brown and so the test was stopped.

### Example 3

Avocado pulp was obtained from a commercial supplier. The avocado pulp was acidified to a pH of 3.5. The pulp was heated for 2 min at a temperature of 75 C. The product was packed. After about 65 days, the package was opened and no browning, darkening or mold formation was observed on the stable product composition of this invention.

### Example 4

A stable puree composition was made by the following process.

Frozen avocado was cut into 3×3×3 mm chunks at a temperature of about −10oC.

A base suspension was prepared by mixing the following ingredients:

| Ingredient | Weight % |
|---|---|
| Thickening Agent | 3.0% |
| (Citrus Fiber) | |
| Sunflower Oil | 4.0% |
| Polysorbate | 0.5% |
| Pectin | 0.3% |
| Potassium Sorbate | 0.1% |
| Water | Balance |

The resulting base composition was mixed to produce a base suspension. The base suspension was homogenized in a colloid mill.

The base and the avocado chunks were mixed in a 4:1 ratio on weight basis and the pH was adjusted to pH 3.7 at 20oC using hydrochloric acid. This product was heated in a surface scraped heat exchanger to about 75° C. It was kept at this temperature for about 2.7 min and subsequently cooled to about 30° C. in a surface scrapped heat exchanger. The stable product was sealed in a package and kept at ambient temperature. After about 65 days, the package was opened and no browning, darkening or mold formation was observed on the stable product composition of this invention.

### Example 5

A base suspension was prepared by mixing the following ingredients:

| Ingredient | Weight % |
|---|---|
| Vegetable oil | 17.6 |
| Vegetable fat SBO 37 | 10.4 |
| Glucose | 8.18 |
| Fiber | 3.9 |
| (Citrus fiber) | |
| Salt | 2.03 |
| Sugar | 1.31 |
| Whey protein | 0.61 |
| Polisorbate 60 | 0.39 |
| Citric acid | 0.3 |
| Potassium sorbate | 0.3 |
| Emulsifier | 0.22 |
| (monoestearate) | |
| Xanthan gum | 0.13 |
| Lecithin | 0.11 |
| Pectin | 0.08 |
| EDTA | 0.01 |
| Water | balance |

The resulting base composition was mixed to produce a base suspension. The base suspension was homogenized in a colloid mill.

The base and the avocado chunks were mixed in a 4:1 ratio on weight basis and the pH was adjusted to pH 3.7 at 20oC using hydrochloric acid. This product was heated in a surface scraped heat exchanger to about 75° C. It was kept at this temperature for about 2.7 min and subsequently cooled to about 30° C. in a surface scrapped heat exchanger. The stable product was sealed in a package and kept at ambient temperature. After about 65 days, the package was opened and no browning, darkening or mold formation was observed on the stable product composition of this invention.

The results of the experiments above indicate that pulps and puree compositions prepared via this invention, unexpectedly, have a superior shelf life.

1-25. (canceled)

26. A method for making a stabilized fruit pulp composition comprising the steps of:
a) harvesting fruit about 1 to 4 weeks prior to being ripe;
b) storing the harvested fruit in a dark room at a temperature from about 10° C. to about 35° C. for less than about 1.5 weeks;
c) in no particular order, peeling, depitting or coring, if necessary, the fruit and cutting or mashing the fruit to produce fruit pulp, the pulp comprising chunks having dimensions of from 1×1×1 mm to 15×15×15 mm;
d) mixing the fruit flesh with about 0.01 to about 5.0% by weight acidulant to produce an acidulant and fruit flesh mixture;
e) heating the acidulant and fruit flesh mixtures to a temperature not over about 90° C. for less than about 4 minutes
wherein the fruit has a hardness factor of at least 300 dynes prior to heating.

27. A method for making a stabilized fruit pulp composition according to claim 26, wherein the fruit is avocado, mango, guava, fig, papaya; kiwi, star fruit, pineapple or a mixtures thereof, preferably the fruit comprises avocado.

28. The method for making a stabilized fruit pulp composition according to claim 26, wherein the stabilized fruit pulp composition comprises from about 50.0 to about 99.0% by weight water; fruit pulp; 0.1 to about 40.0% by weight oil; substantially no quality detrimental enzyme activity after heating.

29. The method according to claim 26, wherein the stabilized fruit pulp composition comprises from about 75.0 to about 99.0% by weight water; fruit pulp; 0.1 to about 20.0% by weight oil.

30. The method according to claim 26, where the fruit is subjected to storage conditions of relative humidity between about 40-70% before being heated.

31. The method according to claim 26, wherein in step e) the acidulant and fruit flesh mixtures is heated for about 10 seconds to about 3.5 minutes.

32. The method according to claim 26, wherein the chunks have dimensions of from about 2×2×2 mm to about 10×10×10 mm.

33. A method for making a stable puree composition, comprising the step of adding the stabilized fruit pulp composition prepared according to claim 26 to a composition comprising a thickening base to produce a stable puree composition.

34. The method according to claim 33, wherein the stable puree composition has a viscosity from about 18,000 to about 30,000 centipoise.

35. The method according to claim 33, wherein the stable puree composition has a pH from at least about 3.0 to less than or equal to about 7.0.

36. The method according to claim 33, wherein the stable puree composition is used as a dressing, dip, spread, cooking additive or baking additive.

37. The method according to claim 33, wherein the stable puree composition further comprises food grade flavoring, food grade coloring, protein powder, preservative, emulsifier, acid, spices, texturizing agent or a mixture thereof.
